(19) United States
(12) Patent Application Publication
(10) Pub. No.: US 2003/0107516 A1
(43) Pub. Date: Jun. 12, 2003

(54) Electronic distress call and position finding system for rescuing distressed people

(76) Inventors: Karl-Heinz Hansmann, Rosrath (DE); Christiane Linkenbach, Rosrath (DE); Lutz Heinen, Cologne (DE)

Correspondence Address: JACOBSON HOLMAN PLLC, 400 SEVENTH STREET N.W., SUITE 600, WASHINGTON, DC, 20004, US

(21) Appl. No.: 10/285,675

(22) Filed: Nov. 1, 2002

Related U.S. Application Data
(63) Continuation of application No. 09/403,014, filed on Dec. 20, 1999, now abandoned.
Application No. 09/403,014 is a 371 of international application No. PCT/DE97/01181, filed on Jun. 12, 1997.

(30) Foreign Application Priority Data
Apr. 16, 1997 (DE) 197 15 869.2

(51) Int. Cl. G01S 5/14

(52) U.S. Cl. 342/357.08; 342/357.09

(57) ABSTRACT

Electronic distress call and position finding system for rescuing distressed people has a receiver with a screen and a distress call transmitter. For evaluating the distress call, it requires the positions of both the receiver and transmitter components. The positions (A) of the receiver (1) and (B) of the distress call transmitter (2) are established by their GPS modules from the data of specialized satellites (4), which orbit the earth on stationary orbits. The distress call transmitter radios its position (B) to the receiver. From the two positions, the distance and direction of the distress call transmitter are calculated. If the system is used for diving, the switched-on receiver remains on the ship, and the distress call transmitter is secured to the diver so that it cannot get lost. When a diver is drifting away, the distress call transmitter is switched on, the system begins to work, and his distance and direction with respect to the ship are displayed on the screen. Then, the rescue of the diver is initiated in a well-aimed manner.

This is a continuation of application no. 09/403,014, filed Dec. 20, 1999, which is a 371 of PCT/DE97/01181, filed Jun. 12, 1997, the disclosure of which is incorporated herein by reference.

Simple distress call systems are based on optical and/or sound signals. Essentially, these are:

life buoys in the form of inflatable balloons for persons floating on the surface of water;

signal colors for intensely coloring the water surface;

signal distress rockets;

small flashlights (in darkness);

signal whistles.

Such distress call systems are often insufficient. With electronic distress call systems available to date, the receivers cannot find the positions of the distress call transmitters when the search for the distress caller always has to cover a large area. Great distances and unfavorable weather conditions (fog, thunderstorm, twilight, reflecting water, swell, storm etc.) can make locating people in distress impossible.

To date, electronic distress call systems have been employed, inter alia, for hospital and care applications, for persons buried alive by avalanches, and for aviation accidents.

In hospital and care applications, a distress call involves only the radio transmission of a personal characterization (name, room number etc.) to a control room. Thus, if the distress caller is outdoors, his position cannot be located.

The locating device for persons buried alive by avalanches works according to the method of approach to the trapped person, i.e., the area of the accident site must first be narrowed down to precisely locate the victim.

Distress call transmitters for accidents in aviation use the international aircraft distress call frequency. Its range is about 160 km in a flat terrain or on a calm sea, and the call can be received by an aircraft flying at an altitude of 6000 m.

### OBJECTS AND SUMMARY OF THE INVENTION

The object of the invention is to provide a distress call and position finding system, which quickly and exactly determines the position of a person in distress, i.e., his distance and direction with respect to the receiver, in any weather and at a distance that exceeds visual and hearing distances.

This object is achieved by the invention of a system with the features of an electronic distress call and position finding system for rescuing distressed people, wherein the system consists of a receiver and at least one distress call transmitter and the receiver comprises a GPS (global positioning system) module for determining its own position and a radio receiver for receiving the distress calls, and the distress call transmitter includes a GPS (global positioning system) module for determining its own position and a transmitter which transmits this position to the receiver as a distress call on a carrier frequency, characterized in that the receiver comprises, in one housing, a computer having a display (screen) for evaluating and representing the data received from the GPS module and the radio receiver in addition to the GPS module and radio receiver, and the distress call transmitter is provided in the same housing as the GPS module.

The invention provides the achievement, whereby, distressed people can attract the attention of someone at their starting point, i.e., the location of the receiver, as soon as possible using the transmitter, without much active assistance, except for switching on the transmitter, so that their rescue can be initiated immediately thereafter.

### BRIEF DESCRIPTION OF THE DRAWING

FIG. 1 is a block diagram, which illustrates one example of the invention.

### DETAILED DESCRIPTION OF THE PREFERRED EMBODIMENTS

In one advantageous embodiment of the invention the housing is splash proof and suitable for portable and stationary use due to the fact that the receiver can be both operated with storage batteries and connected to external power sources. The design according to this embodiment of the invention allows its use in places where no external power source is available, e.g., in an inflatable boat.

In another advantageous embodiment of the invention the housing is equipped with a securing system for securing the transmitter to the person to be protected so that it cannot get lost and interference-free data radio transmission to the receiver is ensured without restricting freedom of movement. The design according to this embodiment of the invention allows its use by divers, in that the receiver remains at the starting point and the distress call transmitter is taken along by the divers during the dive.

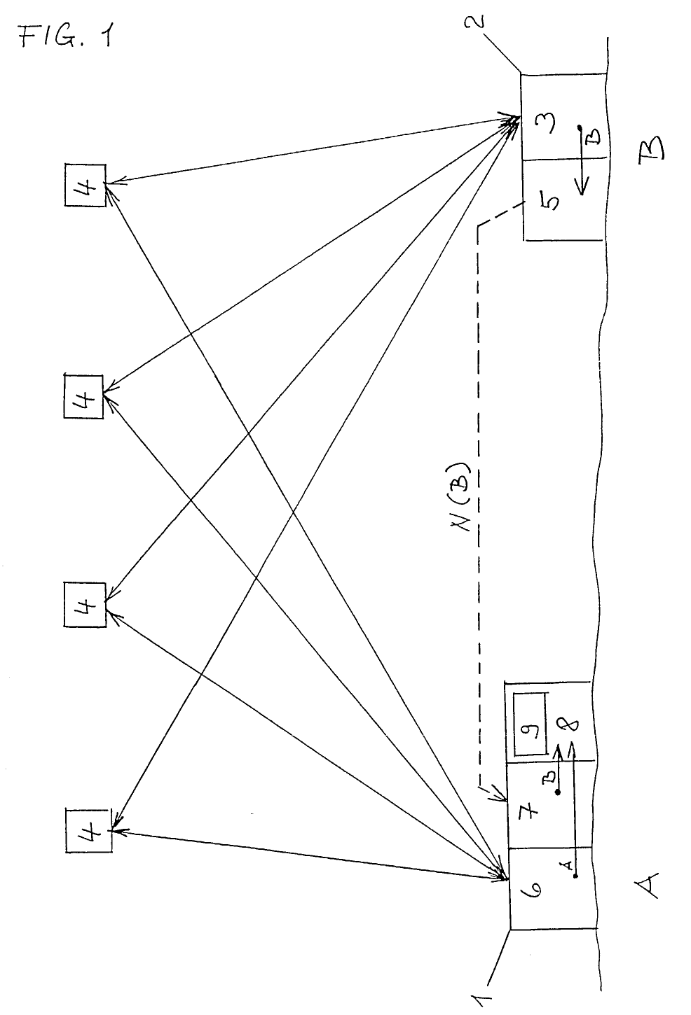

The electronic distress call and position finding system of FIG. 1 consists of a receiver (1) and, depending on the number of persons to be protected, one or more distress call transmitters (2).

The distress call transmitter consists of two components:

a GPS (global positioning system) module (3) which constantly determines its current position (B) using the data from existing specialized satellites (4) which orbit earth on stationary orbits;

a radio transmitter part (5) which transmits the current position (B) of the distress call transmitter as determined by the GPS module (3) as a distress call (N) on a carrier frequency to the receiver (1) for evaluation by the computer (8).

The receiver consists of three components:

a GPS module (6) which constantly determines its current position (A) using the data from existing specialized satellites (4) which orbit earth on stationary orbits;

a radio receiver (7) which receives the position (B) of the distress caller as a distress call (N);

a computer part (8) which calculates the direction and distance of the distress call transmitter (2) with respect to the receiver (1) from the two positions (A) and (B) and shows them on its display (9) in an easily understandable graphic form.

1. An electronic distress call and position finding system for rescueing distressed people,
characterized in that
the system consists of a receiver and at least one distress call transmitter, the number of distress call transmitters corresponding to the number of persons to be protected;
said receiver includes three functional parts in one housing:
a GPS (global positioning system) module for determining its own position;
a radio receiver for receiving the distress calls; and
a computer having a display (screen) for evaluating and representing the data received from the GPS module and the radio receiver;
said distress call transmitter included two functional parts in one housing:
a GPS (global positioning system) module for determining its own position; and
a transmitter which transmits this position to the receiver as a distress call on a carrier frequency.

2. The electronic distress call system according to claim 1, characterized in that
the computer of said receiver calculates the distance and direction of the distress call transmitter with respect to the receiver from its own determined position and the position transmitted from the distress call transmitter and represents them on the display.

3. The electronic distress call system according to claim 1, characterized in that
the housing of said receiver is splashproof and suitable for portable and stationary use i.e., the receiver can be both operated with storage batteries and connected to external power sources.

4. The electronic distress call system according to claim 1, characterized in that
the housing of the distress call transmitter is designed to be waterproof and pressure-tight up to 21 bar=down to 200 m depth of water, possesses an easy-change battery/easy-change storage battery with a charge control and is equipped with a securing system for securing the transmitter to the person to be protected so that it cannot get lost and interference-free data radio transmission to the receiver is ensured without restricting the freedom of movement.
